(19) United States
(12) Patent Application Publication
(10) Pub. No.: US 2024/0396588 A1
(43) Pub. Date: Nov. 28, 2024

(54) PROCESSING SIGNALS, SELECTING AN ACCESS POINT FOR PROCESSING INFORMATION, AND SENDING INFORMATION TO AN ACCESS POINT

(71) Applicant: Telefonaktiebolaget LM Ericsson (publ), Stockholm (SE)

(72) Inventors: Pål FRENGER, Linköping (SE); Erik G. LARSSON, Linköping (SE); Joao VIEIRA, Hjärup (SE); Andres REIAL, Lomma (SE); Omer HALILOGLU, Istanbul (TR)

(21) Appl. No.: 18/714,731

(22) PCT Filed: Dec. 3, 2021
(86) PCT No.: PCT/TR2021/051352

§ 371 Date: May 30, 2024

(51) Int. Cl. H04B 7/024

(52) U.S. Cl. CPC H04B 7/024

(57) ABSTRACT

Methods and apparatus are provided. In an example aspect, a method in a first access point (AP) of processing signals from at least one User Equipment (UE) is provided. The method includes receiving, for each of at least one other access point, information based on signals received at one or more antennas of the other access point from the at least one UE, processing the information based on the signals received at the one or more antennas of the at least one other access point to determine symbol estimates of symbols in the signals, and forwarding information identifying the symbol estimates to a processing node.

### TECHNICAL FIELD

Examples of the present disclosure relate to processing signals, selecting an access point for processing information, and sending information to an access point. In particular examples, the present disclosure may relate to a method in a first access point AP of processing signals from at least one User Equipment (UE), a method in a processing node of selecting a first access point for processing information based on signals from at least one UE, or a method of sending information to a first access point in a second access point.

### BACKGROUND

The project leading to this application has received funding from the European Union's Horizon 2020 research and innovation programme under grant agreement No 101013425.

Distributed multiple-input multiple-output (D-MIMO, also known as “cell-free massive MIMO”, Radio Stripes, or RadioWeaves) is a key technology candidate for the 3rd Generation Partnership Project (3GPP) 6th generation (6G) physical layer. The basic principle behind D-MIMO is to distribute service antennas geographically and have them operate phase-coherently together. In an example D-MIMO architecture, multiple antenna panels (also referred to as access points or APs) are interconnected and configured in such a way that more than one panel can cooperate in coherent decoding of data from a given UE, and more than one panel can cooperate in coherent transmission of data to a UE. Each antenna panel in turn may comprise multiple antenna elements that are configured to operate phase-coherently together. Example implementations may use time-division duplexing (TDD), relying on reciprocity of the propagation channel, whereby uplink pilots transmitted by the UEs are used to estimate both the uplink and downlink channel responses. This type of TDD operation may be referred to as reciprocity-based operation.

To make deployment of a large number of distributed MIMO access points simple and cost efficient, various solutions have been proposed, such as Radio Stripes and RadioWeaves. A common feature is to use a shared fronthaul together with a high degree of integration and miniaturization. An electronic circuit containing the digital signal processor (DSP), antenna panel, and external interfaces (for power supply and data) is called an antenna processing unit, or APU. In this document these will be referred to as access points (APs). An example of an APU or AP 100 is shown in FIG. 1. The AP 100 includes an antenna panel 102 that comprises four antenna elements 104. The AP 100 also includes four external interfaces 106. The external interfaces in the example AP 100 are located at the edges of the AP 100 such that they may communicate with one or more adjacent APs.

Multiple APs, such as the AP 100, may be connected directly or via one or more other APs to a processing node, also referred to herein as a central processing unit (CPU). In one example network 200, shown in FIG. 2, that uses an arrangement referred to as RadioWeaves, APs 202 may be connected to between one and four adjacent APs 202, and at least one of the APs 202 is connected to a CPU 204. Thus, each of the APs 202 may communicate with the CPU 204. In another example network 300, shown in FIG. 3, which uses an arrangement referred to as Radio Stripes, APs are arranged in multiple series arrangements, referred to as stripes 302, such that each stripe 302 includes multiple APs 304. Within a stripe 302, each AP 304 is connected to the two adjacent APs, with the exception of an AP 304 that is furthest from the CPU 306, which AP 304 is connected only to one adjacent AP 304. Another exception is the AP 304 closest to the CPU 306, which is connected to the CPU 306 and one adjacent AP 304. Thus each AP 304 in the stripes 302 can communicate with the CPU 306.

Processing, e.g. uplink reception, can be done in many ways in a D-MIMO system. An overview is presented in Emil Bjömson and Luca Sanguinetti, “Making Cell-Free Massive MIMO Competitive With MMSE Processing and Centralized Implementation,” IEEE Transactions on Wireless Communications, vol. 19, no. 1, pp. 77-90, January 2020.

A common assumption in distributed MIMO is that the channel is reciprocal, and that uplink measurements can be used to estimate both the uplink (UL) and the downlink (DL) channels. In an example network, the number of UEs is denoted by K, the number of APs is denoted L, and the number of antenna elements in each AP is denoted N. For simplicity it is assumed that all APs have the same number of antenna elements, though in other examples the number of antennas may vary between APs. Each UE is assigned an uplink pilot sequence, which may not necessarily be unique, that can be used to estimate the channel between the UE and the AP(s) as well as statistical channel properties such as correlation matrices, average path gain and noise power. When the pilot sequence transmitted by the UE as a pilot signal has been received by one or more APs, the received signal can be used to perform channel estimation. When channel estimation has been performed, uplink data transmission can occur. A signal (e.g. a data signal) is received by one or more APs.

In one example, referred to as Level 4 processing, fully coherent combining of all signals is performed. This allows high performance, but it also has very high complexity as it requires a fully centralized network architecture, such as a central processing unit (CPU) that interconnects with every AP (directly or indirectly, e.g. as shown in FIG. 2 or 3). Signals from all antennas are forwarded to the CPU, which can implement a joint receiver for all users and AP signals. For minimum mean-square error (MMSE) combining, this nominally requires a large matrix inversion of size (NL×NL).

In Level 2 and Level 3 processing, each AP performs a first round of pre-processing using only the signals obtained from antenna elements in that AP, i.e. each AP performs local pre-processing operations. The so-obtained local estimates can then be forwarded to the CPU for a final combining. The difference between Level 2 and Level 3 is that Level 3 uses “optimal combining weights” while Level 2 uses “equal combining weights” when combining the local symbol estimates from each AP. “Equal combining weights” means that the symbol estimates from each AP are combined with weights 1 (they are summed with no special weighting). “Optimal combining weights” refers to that the combining weights are calculated to minimize the error (e.g. in the MMSE sense). APs with strong channels are given large weights and APs with weak channels are given small weights. The matrix inversion needed for calculation of local MMSE combining weights is of size (N×N).

One useful property of Level 2 and Level 3 combining is that the summation of local estimates can be performed sequentially as the signals are communicated from the APs towards the CPU. For example, if APs are configured in a daisy chain fashion such as for example shown in FIG. 3, signals from a first AP may be sent to the CPU via a second AP, which may then forward a combined version of the signals from itself and from the first AP to e.g. a third AP, and so on.

Finally, level 1 processing may be equivalent to a small cell deployment where each UE is assigned only the single best AP based on the average path gain, and each AP performs local processing involving only the UE(s) it is serving.

There is currently no method that provides both good performance and has a low (i.e. scalable) fronthaul capacity and low (i.e. scalable) node processing complexity. In D-MIMO, fully centralized uplink processing (Level 4) has the best performance. However, this requires that all antenna signals in all APs need to be forwarded to the CPU, which is expensive and not scalable. This puts very high requirements on the fronthaul capacity. A star fronthaul topology has the required capacity, but is very expensive to install, requiring one cable per AP. A segmented fronthaul topology has a low cost, but it has limited capacity per AP, as all APs on the same fronthaul cable share the total fronthaul capacity.

Fully centralized MMSE processing (Level 4) is processing heavy as it (requires very large matrix inversion. All UEs need to be processed in the same node in a short time, and thus all UEs share the CPU processing capacity. Processing the UE in only the “best AP” for the UE (e.g. according to Level 1 processing) is less complex, as it requires (less fronthaul and less DSP processing, but the performance is worse since no macro diversity gain is obtained.

Sequential decoding algorithms (like in Level 2 or Level 3) perform poorly when the number of antenna elements per AP is small. With a small number of antenna elements per AP, interference is not suppressed and using sequential additions does not improve the signal to interference and noise ratio (SINR). Distributed processing has so far been applied primarily to sequential (1-D) AP and fronthaul layouts.

### SUMMARY

Examples of this disclosure may provide solutions for signal and information processing that are scalable for arbitrarily large distributed deployments, but that also provide high performance. For example, examples of this disclosure may approach the performance of fully centralized processing (e.g. Level 4 processing) as the size of the set of cooperating access points expands.

One aspect of the present disclosure provides a method in a first access point (AP) of processing signals from at least one User Equipment (UE). The method comprises receiving, for each of at least one other access point, information based on signals received at one or more antennas of the other access point from the at least one User Equipment (UE), processing the information based on the signals received at the one or more antennas of the at least one other access point to determine symbol estimates of symbols in the signals; and forwarding information identifying the symbol estimates to a processing node.

Another aspect of the present disclosure provides a method in a processing node of selecting a first access point for processing information based on signals from at least one User Equipment (UE). The at least one UE is to be served by at least one other access point. The method comprises, for each of the at least one UE, selecting a first access point for processing information based on signals received at one or more antennas of the at least one other access point from the at least one UE. The method also comprises sending, to the at least one other access point, information identifying the first access point selected for each of the at least one UE.

A further aspect of the present disclosure provides a method of sending information to a first access point in a second access point. The method comprises receiving, from a processing node, an indication of a first access point, receiving signals at one or more antennas of the second access point from at least one User Equipment (UE), and sending, to the first access point, information based on signals received at the one or more antennas of the second access point from the at least one UE.

A still further aspect of the present disclosure provides apparatus in a first access point (AP) for processing signals from at least one User Equipment (UE). The apparatus comprises a processor and a memory. The memory contains instructions executable by the processor such that the apparatus is operable to receive, for each of at least one other access point, information based on signals received at one or more antennas of the other access point from the at least one User Equipment (UE), process the information based on the signals received at the one or more antennas of the at least one other access point to determine symbol estimates of symbols in the signals, and forward information identifying the symbol estimates to a processing node.

An additional aspect of the present disclosure provides apparatus in a processing node of selecting a first access point for processing information based on signals from at least one User Equipment (UE). The at least one UE is to be served by at least one other access point. The apparatus comprises a processor and a memory. The memory contains instructions executable by the processor such that the apparatus is operable to: for each of the at least one UE, select a first access point for processing information based on signals received at one or more antennas of the at least one other access point from the at least one UE; and send, to the at least one other access point, information identifying the first access point selected for each of the at least one UE.

A further aspect of the present disclosure provides apparatus for sending information to a first access point in a second access point. The apparatus comprises a processor and a memory. The memory contains instructions executable by the processor such that the apparatus is operable to receive, from a processing node, an indication of a first access point, receive signals at one or more antennas of the second access point from at least one User Equipment (UE), and send, to the first access point, information based on signals received at the one or more antennas of the second access point from the at least one UE.

Another aspect of the present disclosure provides apparatus in a first access point (AP) for processing signals from at least one User Equipment (UE). The apparatus is configured to receive, for each of at least one other access point, information based on signals received at one or more antennas of the other access point from the at least one User Equipment (UE), process the information based on the signals received at the one or more antennas of the at least one other access point to determine symbol estimates of symbols in the signals, and forward information identifying the symbol estimates to a processing node.

An additional aspect of the present disclosure provides apparatus in a processing node of selecting a first access point for processing information based on signals from at least one User Equipment (UE). The at least one UE is to be served by at least one other access point. The apparatus is configured to: for each of the at least one UE, select a first access point for processing information based on signals received at one or more antennas of the at least one other access point from the at least one UE; and send, to the at least one other access point, information identifying the first access point selected for each of the at least one UE.

A further aspect of the present disclosure provides apparatus for sending information to a first access point in a second access point, the apparatus configured to receive, from a processing node, an indication of a first access point, receive signals at one or more antennas of the second access point from at least one User Equipment (UE), and send, to the first access point, information based on signals received at the one or more antennas of the second access point from the at least one UE.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of an antenna processing unit (APU) or access point (AP);

FIG. 2 shows an example of a network;

FIG. 3 shows another example of a network;

FIG. 4 is a flow chart of an example of a method in a first access point (AP) of processing signals from at least one User Equipment (UE);

FIG. 5 shows an example of a network according to an example of this disclosure;

FIG. 6 shows an example of the network of FIG. 5 in a particular stage of forwarding information to an aggregation AP for each UE;

FIG. 7 shows another example of a network according to an example of this disclosure;

FIG. 8 shows an example of the fronthaul signaling in a first pipeline step or time slot in the network of FIG. 7;

FIG. 9 shows an example of the fronthaul signaling in a second pipeline step or time slot in the network of FIG. 7;

FIG. 10 is a flow chart of an example of a method in a processing node of selecting a first access point for processing information based on signals from at least one UE;

FIG. 11 is a flow chart of an example of a method in a second access point of sending information to a first access point;

FIG. 12 is a schematic of an example of an apparatus in a first AP of processing signals from at least one UE;

FIG. 13 is a schematic of an example of an apparatus in a processing node of selecting a first access point for processing information based on signals from at least one UE;

FIG. 14 is a schematic of an example of an apparatus in a second access point for sending information to a first access point;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17 to 20 are flowcharts illustrating methods implemented in a communication system including a host computer, a base station (or access point) and a user equipment.

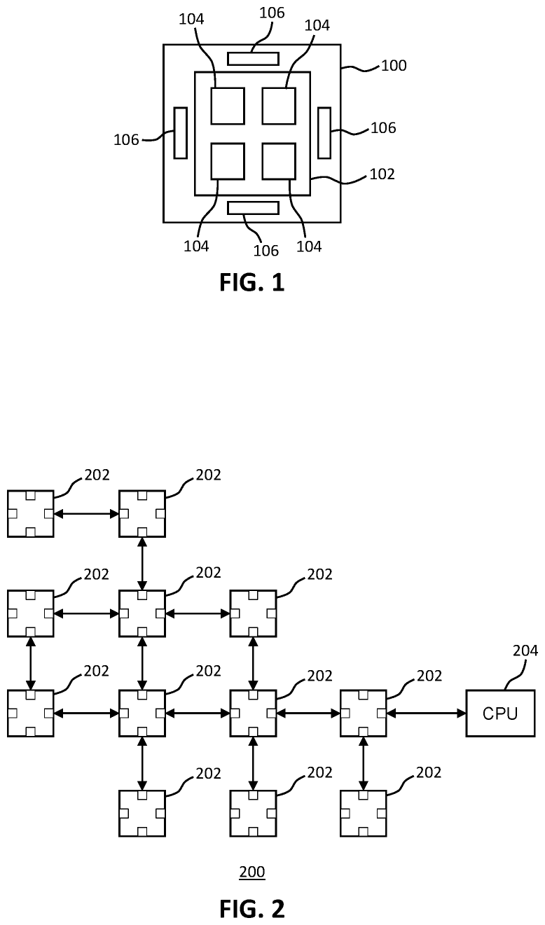

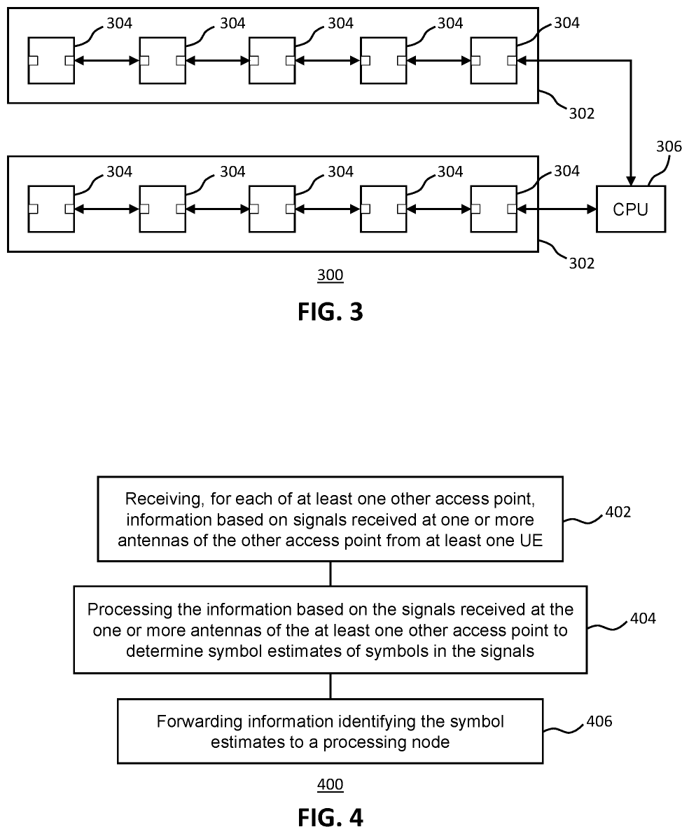

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Examples of this disclosure may solve one or more of the problems described above by implementing uplink processing via distributed and parallel processing and routing. For example, a framework for sequential processing is provided in some examples to implement a suitable hybrid processing scheme between the different processing schemes (Levels 1-4) described, above so that desirable performance and complexity tradeoffs can be obtained. In particular examples, one group of cooperating APs is assigned per UE. The assignment may be for example based on channel statistics (e.g. average path gain), so that close-to-optimal performance (e.g. the performance of level 4 processing) may be obtained when the cooperating group of APs is large enough. For each UE, in some examples, UE, phase coherent signal processing and sequential signal routing may occur between its associated group of APs, which may enable improved interference suppression properties, unlike levels 2 and 3 described above. This may also have relatively low requirements for fronthaul inter-connects that allow APs and a processing node such as a CPU to communicate with each other, which may allow for good scalability of the system while ensuring good performance.

In particular examples, a distributed MIMO system may be provided that comprises multiple access points (APs) connected to a processing node (e.g. a CPU) through a segmented fronthaul. Each fronthaul segment may connect one AP with a neighboring AP or with the processing node. The fronthaul can in some examples have a 1D structure, similar to Radio Stripes described above, a 2D or a 3D-structure (e.g. RadioWeaves), a tree structure, a ring structure, or any other suitable type of structure. An AP can communicate with another AP or with a CPU through one or several fronthaul segment hops. Multiple fronthaul segments can be active simultaneously.

Each UE is in some examples associated with a set of cooperating APs and an aggregation AP, also referred to herein as a first AP, which may for example perform processing of signals received at antennas of the set of cooperating APs (referred to herein as antenna signals) from a UE to determine symbol estimates. Fronthaul segments may for example simultaneously forward antenna signals (e.g. information identifying the antenna signals) from the set of cooperating APs to the aggregation AP for each UE. Different aggregation APs may used in some examples to process uplink signals for different UEs. Multiple aggregation APs can be active simultaneously.

In some examples, the processing node such as a CPU may control allocation of hardware resources for UL processing. For example, the CPU may determine which APs may be a cooperating AP set and aggregation AP for each UE. The processing node may also in some examples determine allocation of fronthaul segment resources (including routing decisions) for local forwarding of antenna signals to aggregation APs and/or allocation of processing capacity (i.e. selection of first or aggregation AP for each UE). Decoded signals (e.g. the symbol estimates) may be forwarded from aggregation APs to the processing node.

As indicated above, examples of this disclosure may provide solutions for signal and information processing that are scalable for arbitrarily large distributed deployments, but that also provide high performance. For example, examples of this disclosure may approach the performance of fully centralized processing (e.g. Level 4 processing) as the size of the set of cooperating access points expands.

FIG. 4 is a flow chart of an example of a method 400 in a first access point (AP) of processing signals from at least one User Equipment (UE). The first AP may also be referred to as an aggregation AP. The method 400 comprises, in step 402, receiving, for each of at least one other access point, information based on signals (e.g. pilot signals and/or data signals) received at one or more antennas of the other access point from the at least one UE. The signals may thus be for example antenna signals that are received at antennas of the other AP(s). The other AP(s) may be for example a cooperating set or group of APs as referred to herein, and may be for example a group of APs that are serving the UE(s).

Step 404 of the method comprises processing the information based on the signals received at the one or more antennas of the at least one other access point to determine symbol estimates of symbols in the signals. Step 406 of the method 400 comprises forwarding information identifying the symbol estimates to a processing node such as a CPU.

Thus, for example, instead of sending information identifying signals (e.g. antenna signals) to a processing node such as a CPU, APs may instead send the information to an AP (the first AP or aggregation AP) for processing. This may in some examples allow for diversity gains for communication between the UE(s) and the other AP(s) while at the same time avoiding the need to forward all of the information from all APs in the network to the processing node. Instead, the symbol estimates are determined by the first AP and forwarded to the processing node, which reduces the processing requirements of the processing node as well as reducing usage of backhaul interconnecting the APs in the network and the processing node.

The group of cooperating APs may in some examples include the first AP as well as the other AP(s) referred to above. Therefore, in such examples, the method 400 may comprise receiving signals at one or more antennas of the first access point from the at least one UE. Processing the signals from the at least one other access point to determine symbol estimates of symbols in the signals in step 404 may thus comprise processing the signals received at the one or more antennas of the at least one other access point and the signals received at the one or more antennas of the first access point to determine the symbol estimates of the symbols in the antenna signals.

Examples of how the cooperating group or set of APs is determined are provided as follows. A set of cooperating APs can be determined for each UE based on uplink pilot transmission from each UE (e.g. average path gain estimation). The decision to include an AP in its cooperating set can be based on for example whether the average path-gain is above a threshold, the smallest set of APs that receive a predetermined proportion of the total received pilot power in all APs, a predetermined number of APs with the best estimated path gain, or any other suitable manner for determining whether an AP should be included in the set for the UE. Alternatively, for example, the cooperating AP set may be selected based on the total power that the AP set receives from a signal such as a pilot signal transmitted by the UE. For example, it may correspond to a number APs that receive the highest total power of the entire AP network, such that the sum of the power collected by such these APs is above a pre-defined performance threshold. Thus, if power collected by APs is low then the set will contain more APs.

The decision to include the AP in a cooperating set for a UE may in some examples also be based on the total number of APs and UEs and the available computing and routing resources, so that, for each UE, a set of APs is included such that processing (e.g. in APs) and fronthaul budgets are not exceeded.

An aggregation AP (referred to herein also as a first AP) may also be determined per UE (or per AP set) in some examples. The aggregation AP is for example the AP to which all UL signals received by the AP set are routed to. The aggregation AP need not be the AP yielding the best performance in the cooperating AP set, or may even not belong to the cooperating AP set, in some examples. The aggregating AP may be for example an AP along a fronthaul path from one AP of the cooperating AP set (e.g. located at an edge of the set) towards the processing unit, and/or may be an AP that has sufficient processing resources available. In some examples, the aggregation AP is in the center of the cooperating AP set and is included in the cooperating AP set, though alternatively for example the aggregation AP may be selected as the AP in the set that is closest to the processing node (e.g. fewest fronthaul hops to the processing node). By selecting an aggregation AP that is close to the processing node, in some examples, the resulting symbol estimates may have a shorter remaining distance to be forwarded before they reach the processing node (i.e. less fronthaul resources are needed for this step).

It may in some examples be desirable to have different aggregation APs for all UEs, as far as possible, to enable as much parallel or distributed processing as possible. it may thus also be desirable in some examples to ensure that fronthaul communication of information identifying signals to the aggregation APs, and symbol estimates from the aggregation APs will not collide on the fronthaul. Here, collision may be for example the case where signals associated with different UEs are to be sent over the same fronthaul segment link at the same time instance. Hence, selection of aggregation APs may in some examples be performed along with the process of determining data routing and distribution of capacity of fronthaul messages on parallel fronthaul segments.

Planning of how information is routed on the fronthaul may in some examples be done with a long periodicity. For example, this may be done when a UE enters or exits the system (e.g. attaches to or leaves the network), or when an AP set for UE(s) needs to be updated, may be done for example based on long term channel statistics. The processing node may be responsible for this hardware resource scheduling of processing and fronthaul capacity in some examples. Since this scheduling changes relatively slowly (e.g. compared to instantaneous changes in the channel or fading), it is possible to use an advanced algorithm that involves sending detailed power level and routing information via the fronthaul from the APs to the processing node, where distribution and retrieval of such information may be spread out over many data transmission intervals.

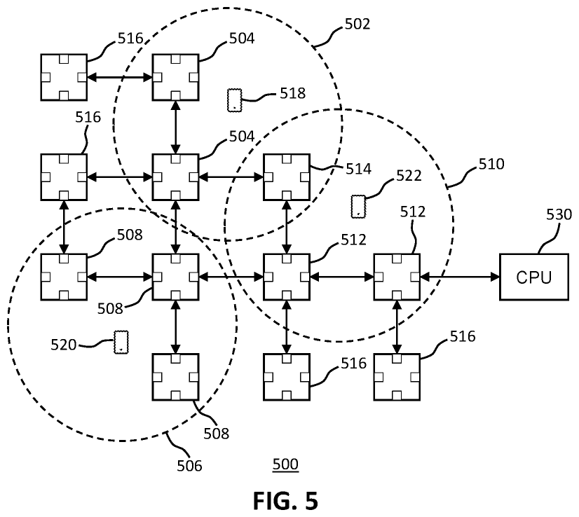

FIG. 5 shows an example of a network 500. The network includes a first set 502 of APs 504, a second set 506 of APs 508 and a third set 510 of APs 512. In the example shown, an AP 514 belongs to both the first 502 and third 510 sets, and the network 500 also includes other APs 516 that are not part of any of the sets shown (though may belong to other sets). In the example shown, each set contains three APs, though in other examples each set may contain any number of one or more APs, and the number may vary between sets. Each AP may also belong to any number of sets.

The sets 502, 506 and 510 are identified in FIG. 5 by circles, which may in some examples indicate the area where the uplink received power for each UE in the network is above a threshold. For example, the circle for set 502 may indicate where the uplink power received from a first UE 518 is above the threshold, the circle for set 506 may indicate where the uplink power received from a second UE 520 is above the threshold, and the circle for set 510 may indicate where the uplink power received from a third UE 522 is above the threshold. For each UE, the AP set selection criterion for the set of cooperating APs associated with the UE is the APs covered by the circle corresponding to that UE (i.e. that receives above a threshold power from the UE, e.g. for a pilot signal transmitted by the UE). One of the APs in the cooperating set for each UE is determined to be the first AP or aggregation AP for this UE, though in other examples an AP outside of the set may be selected to be the first AP or aggregation AP for the set.

Referring back to the method 400 of FIG. 4, in some examples, receiving the information based on signals received at one or more antennas of the at least one other access point may comprise receiving the information for a plurality of other access points simultaneously over a plurality of fronthaul segments connected to the first access point. For example, the first AP for a cooperating AP set may send the information to the associated first AP or aggregation AP simultaneously or in parallel over multiple fronthaul links to the first AP.

In some examples, the first AP or aggregation AP may also be a member of a further AP set for which it is not the first AP or aggregation AP. The first AP will then forward signals received from UEs associated with the further set to the aggregation AP associated with that further set. Thus, for example, the method 400 may comprise receiving further signals at one or more antennas of the first access point from at least one further UE (e.g. associated with the further set), and sending information based on the further signals to a further access point, where the further access point may be for example the aggregation AP associated with the further set. The at least one other access point may include the further access point (thus for example the aggregation AP for the further set may be one of the at least one other access point referred to above, e.g. in connection with step 402 of the method 400). The further access point may be identified by the processing node, e.g. as an indication of the further access point received from the processing node.

The information based on the further signals may comprise for example information identifying the further signals from the one or more antennas of the first access point. Alternatively, for example the information based on the further signals may comprise information identifying antenna signals from the one or more antennas of the first access point combined with weights based on channel responses between each of the at least one further UE and each of the one or more antennas of the first access point. Information identifying a magnitude of a vector representing the antenna signals may also be sent to the further access point. Examples of these features are described in more detail later in this disclosure.

Sending the information based on the further signals to the further access point may in some examples comprise sending information identifying signals received at the one or more antennas of the first access point if a number of the at least one further UE is greater than a number of the one or more antennas of the first access point, and sending information identifying signals received at the one or more antennas of the first access point combined with weights based on channel responses between each of the at least one further UE and each of the one or more antennas of the first access point if the number of the at least one further UE is greater than the number of the one or more antennas of the first access point. Thus, for example, information that is sent may be the information that is smaller or has less data volume depending on the relative numbers of the UE(s) and antennas of the first access point (from which antenna signals may be forwarded to the further AP for processing).

In some examples, receiving, for each of one or more of the at least one other access point, the information based on signals received at one or more antennas of the other access point in step 402 of the method 400 comprises receiving information identifying the signals from the one or more antennas of the other access point.

In some examples, receiving, for each of one or more of the at least one other access point, the information based on signals received at one or more antennas of the other access point in step 402 of the method 400 comprises receiving information identifying the signals received at the one or more antennas of the other access point combined with weights based on channel responses between each of the at least one UE and each of the one or more antennas of the other access point. The method 400 may also comprise receiving, for each of one or more of the at least one other access point, information identifying a magnitude of a vector representing the signals received at the one or more antennas of the other access point. Examples of these features are provided later in this disclosure. Processing the information based on the signals received at the one or more antennas of the at least one other access point to determine symbol estimates of symbols in the antenna signals in step 404 of the method 400 may thus in some examples comprise processing the information based on the signals received at the one or more antennas of the at least one other access point and the information identifying a magnitude of a vector representing the antenna signals to determine symbol estimates of symbols in the antenna signals.

In some examples, the method 400 may comprise receiving, from at least one additional first access point, information identifying additional symbol estimates of symbols in signals from at least one additional UE, wherein the information identifying additional symbol estimates of symbols in signals from at least one additional UE is received simultaneously with forwarding information identifying the symbol estimates to a processing node. This may occur for example where the first AP performing the method 400 is along a line of fronthaul segments between a different aggregation AP (e.g. for a different UE or AP set) and the processing node, which symbol estimates from that aggregation AP are forwarded to the processing node. In some examples, receiving, from at least one additional first access point, information identifying additional symbol estimates of symbols in signals from at least one additional UE may comprise receiving the information in a first time slot, and the method further comprises forwarding the information identifying the additional symbol estimates to the processing node in a second time slot after the first time slot. Thus for example information may be exchanged in the network using the fronthaul segments in a time-slotted or pipelined fashion.

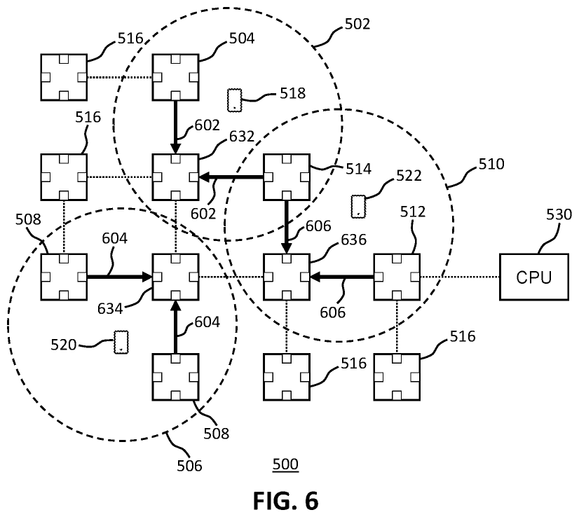

In a particular example, which may occur once the set of cooperating APs and the aggregation AP are selected for each UE in examples where that process is performed, the antenna signals (or sufficient statistics representing the antenna signals) are forwarded from the cooperating APs to the aggregation AP. Such antenna signals may comprise for example channel estimates and received UL data antenna signals. There may be no collisions on the fronthaul in this example. This may be because there are no fronthaul segment links that are utilized by different AP sets. An example of this is shown in FIG. 6, which shows the network 500 of FIG. 5 in a particular stage of forwarding this information to the aggregation AP for each UE. In the example shown, information for UE 518 is sent from APs in set 502 to the aggregation AP for that UE 518 using fronthaul links 602; information for UE 520 is sent from APs in set 506 to the aggregation AP for that UE 520 518 using fronthaul links 604; and information for UE 522 is sent from APs in set 510 to the aggregation AP for that UE 522 using fronthaul links 606. This may all occur simultaneously as no fronthaul link or segment is used to transfer information from multiple APs or UEs at the same time. Note that AP 514 forwards information for multiple UEs simultaneously using multiple segments 602 and 606. The avoidance of collisions may be achieved in some examples by appropriate selection (e.g. by the processing node 530) of the AP sets and the aggregation AP associated with each UE. This may be an example of step 402 of the method 400, where first AP (the aggregation AP) may receive information from multiple other APs. Note that in some cases, there may be another AP between the aggregation AP and one of the other APs, e.g. there may be multiple fronthaul hops between the other AP and the aggregation AP. In such cases, it may take multiple time slots for information to be transferred from the other AP to the aggregation AP. The first APs or aggregation APs for the sets 502, 506 and 510 are labelled 632, 634 and 636 respectively. Additionally or alternatively, in some examples, collision avoidance may be achieved as follows. The processing node (e.g. CPU) in a network may have control of which UEs are allowed to transmit simultaneously in the uplink. As a result, the processing node can avoid co-scheduling of UEs that would result in fronthaul resource conflicts and/or poor or over-utilization of processing and fronthaul resources.

In examples of step 404 of the method 400, each aggregation AP in the network performs local processing (e.g. fully coherent combining of UL data symbols) and produces symbol estimates of the received uplink data for each UE, which in some examples may be soft-symbols or soft-bits.

The soft-symbols for different UEs may in some examples be obtained in different aggregation APs, and there may be a different number of fronthaul segment hops between each aggregation AP and the processing unit. Thus, in the example shown in FIG. 6, the aggregation AP 632 for set 502 may have four fronthaul segment hops to the CPU 530, the aggregation AP 634 of set 506 may have three hops and the aggregation AP 636 of set 510 may have two hops. Thus for example the procedure for transferring symbol estimates (e.g. in step 406 of the method 400) from all aggregation APs to the processing unit may be pipelined. In the example of FIG. 6, information on signals from UE 518 received by set 502 of APs may be transferred from aggregation AP 632 to CPU 530 in four steps (e.g. using four fronthaul segments, where each AP along the line towards the CPU forwards the information using the next segment in the next step). Similarly, information on signals from UE 520 received by set 506 of APs may be transferred from aggregation AP 634 to CPU 530 in three steps, and information on signals from UE 522 received by set 510 of APs may be transferred from aggregation AP 636 to CPU 530 in two steps. Symbol estimates may in some examples be routed via different paths (e.g. not necessarily the shortest or most direct path) to avoid collisions and queuing in the fronthaul segments. In some examples, the processing node can coordinate this process.

Examples of hardware resource scheduling and data transfer routing coordination are now described as follows. In some examples, there may be limited processing capability in each AP in the network. Since there are many APs, the total processing capability may be significant as several aggregation APs can process information relating to several UEs in parallel. Assume that each DSP in each AP can process at most K_{UE} UEs within a time budget (e.g. K_{UE}=1 in the example shown in FIG. 6). One of at least two example approaches for obtaining a symbol estimate at the aggregation AP via distributed processing can be used. In a first example, all information identifying signals received at APs in a cooperating set may be routed to the aggregation AP associated with the UE(s).

In a second example, information may be combined coherently and cumulatively along the route; a soft symbol estimate arrives at the aggregation AP. That is, for example, some partial combining of signals can occur in the cooperating APs in a set. A cooperating AP along the path to the aggregation AP may also perform some pre-processing of signals from cooperating APs that it forwards. This cumulative combining strategy may be sub-optimal compared to processing all signals at the aggregation AP, for example in cases where weight solution information cannot be distributed to the cooperating APs, but this approach may relax the requirements in terms of fronthaul capacity and processing capabilities needed at least some APs in the network. Weight solution information may for example inform the aggregating AP (or a cooperating AP that is performing partial combining of signals) how to combine the soft symbols from all cooperating APs in an MMSE optimal manner. This additional information, if sent to cooperating AP(s), will use fronthaul capacity.

In some examples, routing information from other APs (e.g. APs in a cooperating set) to the aggregation AP may include multiple routes, for example where information from different APs reaches the aggregation AP via different routes. Cumulative combining may then be applied along each route by APs in the set along that route to provide soft symbol estimates based on signals arriving at multiple APs along that route, and these soft symbol estimates from each route may be summed at the aggregation AP. If the aggregating AP is part of the cooperating AP set, it adds its contribution to the cumulatively combined symbol estimate(s) by performing a similar cumulative combining operation.

Fronthaul capacity is limited, but parallel fronthaul segments can in some examples be active simultaneously to provide sufficient total fronthaul capacity for antenna element signal forwarding. In a particular example, it is assumed that each fronthaul segment can forward antenna signals from at most M_{FH} nearby APs to an aggregation AP. If M_{FH}=1, for example, only antenna signals from APs that are direct neighbors to the aggregation AP can be forwarded to the aggregation AP. If M_{FH}=2, antenna signals from APs that are neighbors of neighbors to the aggregation AP can also be forwarded. This constraint could be relaxed if cumulative combining (as noted above) could be supported.

In an example, a greedy algorithm that allocates hardware resources (AP processing and fronthaul resources) for uplink processing can operate by allocating resources to users sequentially. In this particular example, the following steps are performed:
1. Select for a first UE (UE₁) the cooperating AP set and the aggregation AP, for example using any of the example methods disclosed herein. For example, select APs that add up to 90% of the sum uplink path-loss, or select the Q best APs for this UE, for some pre-determined number Q. The first UE may be selected as the UE with best estimated overall link quality among all UEs.
2. Mark distributed AP processing resources, e.g. {AP_number, time_instant} pairs on the transfer route, and fronthaul segment resources, e.g. {segment_number, time_instant} pairs on the transfer route, that will be used to transfer information from the APs to the aggregation AP as “occupied”. Here, marking a resource occupied may mean that the segment or DSP is no longer available for other operations, or it may mean that its remaining capacity is decreased (e.g. for APs that can perform multiple combining operations or fronthaul segments that can carry multiple transitions per time instant).
3. Determine a route for the transfer of symbol estimates from the aggregation AP to the processing node and mark the used resources, e.g. {segment_number, time_instant} pairs for on the transfer route, as “occupied”.
4. For the next UE, e.g. the one with best overall link among the remaining UEs, select the cooperating AP set, aggregation AP, and a forwarding route from the aggregation AP to the processing node from the remaining free resources according to steps 1-3.
5. Continue to schedule UEs and allocate resources according to steps 1-4 until no more UE can be scheduled in this transmission time interval (TTI).

In some examples, for a given routing delay budget, e.g. based on a latency constraint, selected fronthaul segments may be invoked/used at delayed time instants if the preferred time instants (e.g. immediate transfer over the segment) are occupied, subject to not exceeding the delay budget. Alternatively, for example, a longer route may be selected if resources on the shortest route or on another preferred route are not available, again subject to meeting the delay budget.

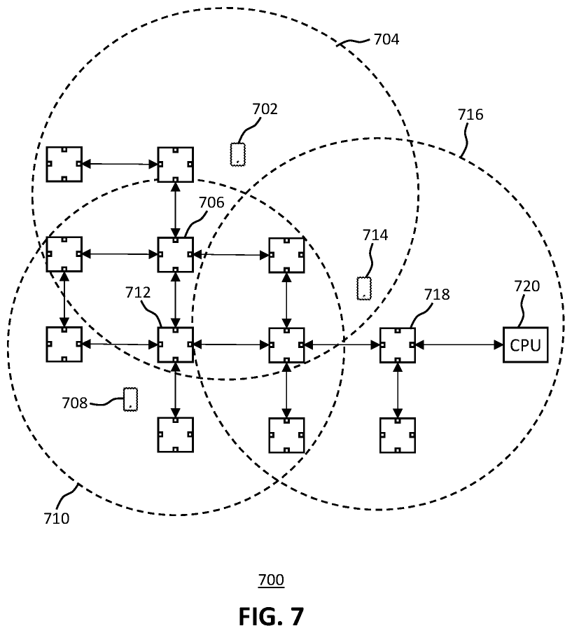

FIG. 7 shows another example of a network 700 in which a cooperating AP set for a UE is larger than those shown in FIGS. 5 and 6. In the example shown in FIG. 7, a UE 702 is associated with a first AP set comprising APs within a circle 704, which has an aggregation AP 706. Another UE 708 is associated with a second AP set comprising APs within a circle 710, which has an aggregation AP 712. Another UE 714 is associated with a third AP set comprising APs within a circle 716, which has an aggregation AP 718. Thus set 704 includes seven APs, set 710 includes eight APs, and set 716 includes five APs.

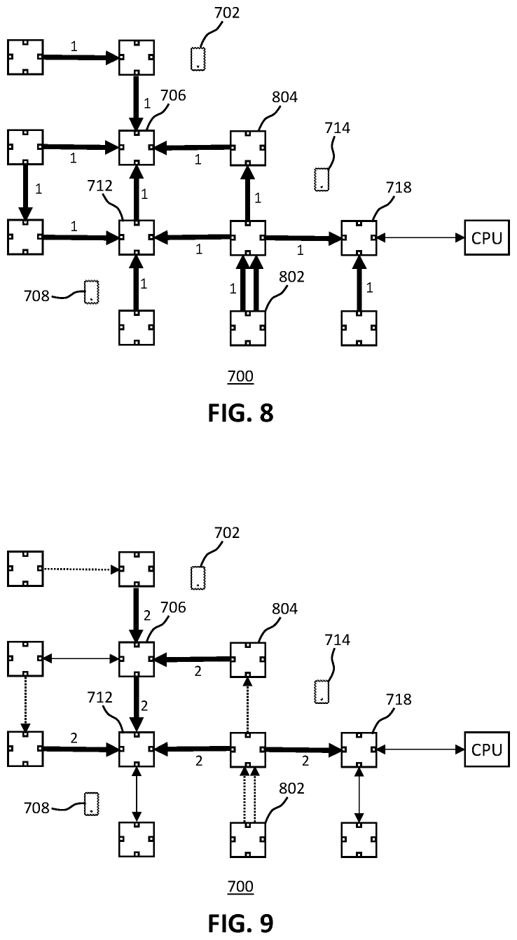

In this example, two fronthaul-segment pipeline steps (or time slots) are needed for all measured signals need to arrive to their respective aggregation APs, as all APs are up to two fronthaul hops from the respective aggregation AP (including APs that are in multiple sets). One example solution for the fronthaul signaling in the first pipeline step or time slot is depicted in FIG. 8, and one example solution for the fronthaul signaling in the second pipe-line step is depicted in FIG. 9. In FIGS. 8 and 9, a number next to each arrow representing a fronthaul segment (all 1 in FIG. 8) indicates the pipeline step or time slot in which the fronthaul segment is used for information forwarding, and the direction of the arrow shows the direction of information transfer. A double arrow from AP 802 in FIG. 8 represents information relating to two UEs (708 and 714) being transferred in the first pipeline step or time slot (this information is sent to two different APs in the next time slot in FIG. 9). Note that information based on signals received at AP 804 cannot reach the aggregation AP associated with UE 708 or 714 in this example, because the fronthaul links that would be used are occupied with forwarding other signals in the first pipeline or time slot as shown in FIG. 8. Thus, in this example, AP 804 is not used for forwarding signals from UEs 708 and 714.

In the examples shown in FIGS. 8 and 9, it is assumed that in each pipeline step or time slot an AP can do one or more of the following over each fronthaul segment that it is connected to:
Forward its own antenna signals to a neighboring AP
Receive forwarded antenna signals from a neighboring AP
Forward previously received antenna signals to a neighboring AP

It is also assumed in these examples that each fronthaul segment can operate in half-duplex mode, i.e. it can transfer information in one direction at a time (e.g. in each time slot or pipeline step). However, in other examples, some or all fronthaul segments may support full-duplex operation whereby information may be transferred in both directions in each time slot or pipeline step.

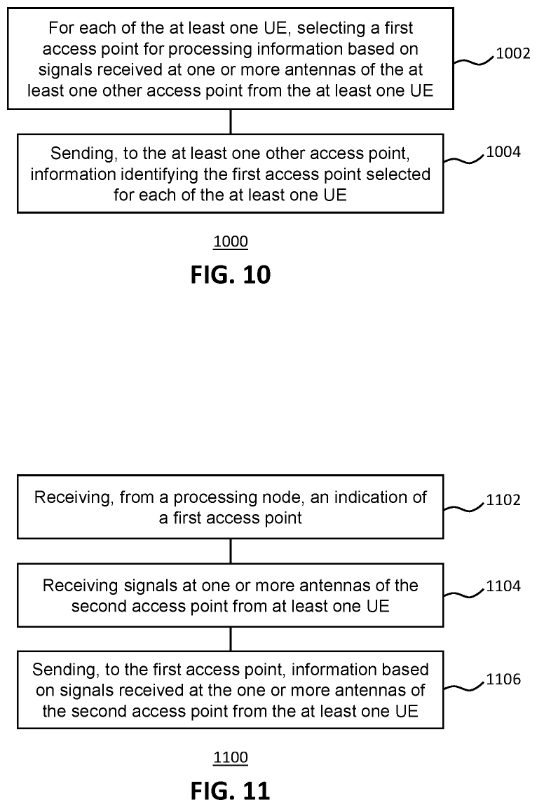

FIG. 10 is a flow chart of an example of a method 1000 in a processing node of selecting a first access point for processing information based on signals from at least one User Equipment (UE), wherein the at least one UE is to be served by at least one other access point. In some examples, the processing node may be the processing node or CPU referred to in any of the examples described herein and/or shown in any of FIGS. 5-9. The method 1000 comprises, in step 1002, for each of the at least one UE, selecting a first access point (e.g. an aggregation access point) for processing information based on signals (e.g. pilot signals and/or data signals) received at one or more antennas of the at least one other access point from the at least one UE. The at least one other access point may comprise for example a group of access points to serve the at least one UE. The group of access points may in some examples include the first access point selected for one or more of the at least one UE.

The method 1000 also comprises, in step 1004, sending, to the at least one other access point, information identifying the first access point selected for each of the at least one UE. In some examples, the first access point may perform any example of the method 400 described herein.

In some examples, the at least one UE comprises a plurality of UEs, and the method comprises selecting a different first access point for different UEs of the plurality of UEs. Thus, for example, the number of aggregation APs in the network may be up to the number of UEs served by the network.

In some examples, sending, to the at least one other access point, the information identifying the first access point selected for each of the at least one UE in step 1004 causes each other access point to send the information based on signals received at one or more antennas of the other access point from a UE to the first access point (e.g. the aggregation access point) selected for the UE.

The method 1000 may in some examples comprise receiving, from each first access point, information identifying symbol estimates of symbols in the signals received at the one or more antennas of the at least one other access point from a UE for which the first access point is the selected first access point.

In some examples, selecting the first access point for a UE for processing information based on signals received at one or more antennas of the at least one other access point from the UE in step 1002 comprises, for each candidate first access point, determining a number of forwarding steps for each of the at least one other access point to forward the information based on the signals received at one or more antennas of the other access point to the candidate first access point. The candidate first access point that has a lowest maximum number of forwarding steps may then be selected as the first access point.

FIG. 11 is a flow chart of an example of a method in a second access point of sending information to a first access point. The method comprises, in step 1102, receiving, from a processing node, an indication of a first access point (e.g. as a result of the method 1000 shown in FIG. 10), which may be for example an aggregation AP for a UE. Step 1104 of the method 1100 comprises receiving signals (e.g. pilot and/or data signals) at one or more antennas of the second access point from at least one User Equipment (UE). Step 1106 of the method 1100 comprises sending, to the first access point, information based on signals received at the one or more antennas of the second access point from the at least one UE. In some examples, the first access point then performs any example of the method 400 described herein. In some examples, a group of access points is serving the at least one UE, and the group of access points includes the second access point. Also, in some examples, the group of access points may include the first access point.

In some examples, the method 1100 also comprises receiving, from at least one other access point, information based on signals received at one or more antennas of the at least one other access point from the at least one UE, and forwarding the information based on the signals received at the one or more antennas of the at least one other access point to the first access point. The second AP may thus for example be located along a route from the at least one other access point to the first AP, and thus will forward information from the at least one other access point to the first access point (e.g. for processing in accordance with the method 400).

Sending, to the first access point, the information based on signals received at the one or more antennas of the second access point in step 1106 in some examples comprises sending information identifying the signals received at the one or more antennas of the second access point.

In some examples, sending, to the first access point, the information based on signals received at the one or more antennas of the second access point in step 1106 comprises sending information identifying the signals received at the one or more antennas of the second access point combined with weights based on channel responses between each of the at least one UE and each of the one or more antennas of the second access point. The method 1100 may also in some examples comprise sending information identifying a magnitude of a vector representing the signals received at the one or more antennas of the second access point to the first access point. Examples of these features are described further later in this disclosure. Sending the information based on the signals to the first access point in step 1106 may in some examples comprise sending information identifying signals received at the one or more antennas of the second access point if a number of the at least one UE is greater than a number of the one or more antennas of the first access point, and sending information identifying signals received at the one or more antennas of the second access point combined with weights based on channel responses between each of the at least one UE and each of the one or more antennas of the second access point if the number of the at least one UE is greater than the number of the one or more antennas of the first access point.

In some examples, the first access point is associated with the at least one UE (e.g. the first access point is the aggregation AP for the UE). The method may thus in some examples comprise receiving, from a processing node, an indication of a further first access point associated with at least one further UE, receiving signals at one or more antennas of the second access point from the at least one further UE, and sending, to the further first access point, information based on signals received at the one or more antennas of the second access point from the at least one further UE. The at least one further UE may thus be associated with a different aggregation AP.

The method 1100 may in some examples comprise receiving, from at least one additional first access point, information identifying additional symbol estimates of symbols in signals from at least one additional UE, wherein the information identifying additional symbol estimates of symbols in signals from at least one additional UE is received simultaneously with sending the information based on signals received at the one or more antennas of the second access point from the at least one UE to the first access point. In some examples, receiving, from at least one additional first access point, information identifying additional symbol estimates of symbols in signals from at least one additional UE may comprise receiving the information in a first time slot, and the method further comprises forwarding the information identifying the additional symbol estimates to a processing node in a second time slot after the first time slot.

Example algorithms of how a first AP or aggregation AP is selected for a UE are now described. In an example, for each AP, an integer is obtained that indicates the number of fronthaul forwarding steps that are required for all APs in the cooperating set to forward information based on antenna signals from those APs in the cooperating set to this AP in the context of serving a given UE. The AP with the smallest integer can then be identified and selected to be the aggregation AP for this UE. Note that the aggregation AP does not necessarily belong to the set of cooperating APs, though it may belong to the set in some examples.

An example algorithm can be designed as follows:
Select a set of cooperating APs for a UE (e.g. path gain sums up to 90% of total for the UE)
For each AP t in the cooperating set, determine the maximum fronthaul distance/number of hops (along a shortest path) to any other AP in the set. Call this distance the “edge distance” associated with the AP l.
Determine which AP or APs have the smallest edge distance. Select this, or one of these APs, to be the aggregation AP for this UE.
If there are multiple candidates, pick the AP closest to the CPU, or do a random selection.

In a related example, the determining step may additionally include the distance of the candidate aggregation APs to the CPU as a criterion. In that case, the AP is selected whose edge distance plus distance to the CPU is the smallest.

Note that there are many variants of this algorithm. In other examples, an alternative metric to select the aggregation AP for a UE is to determine the number of cooperating APs that can send their antenna signals to this AP in 1, 2 or 3 fronthaul forwarding steps and then select the AP with the largest metric as the aggregation AP.

Examples of how antenna signals (e.g. signals received at antennas of an AP from a UE) may be combined with other antenna signals and/or weights are now described as follows. Examples provided below may indicate to what extent antenna signals can be locally processed at each access point. Consider the uplink of a network with L access points, each equipped with N antennas, serving K single-antenna terminals. Let G₁ be an N×K matrix that contains the channel responses between the N antennas at access point l and the K terminals. The complete channel state is defined by {G₁, . . . , G_{L}}. Suppose that G₁, . . . , G_{L} are known, for example, by having the terminals transmit mutually orthogonal pilots with sufficient power. At a given time instant, the K terminals collectively transmit the vector s (of dimension K). Specifically, the k^{th} terminal transmits sₖ.

In white Gaussian noise, which is independent and identically distributed across different APs, the log-likelihood function for the detection of s is equal to (up to irrelevant constants):

$$\\ {\sum }_{l = 1}^{L} {‖ {y}_{l} - {G}_{l} s ‖}^{2} .$$

Specifically, maximum-likelihood detection of s amounts to finding the vector s for which this metric is minimized. This vector can be found through any suitable method. For example, in approximations that rely on zero-forcing or minimum mean square error (MMSE) linear processing may be used, and they are effective when the system is overdetermined (NL>>K).

The metric above can be written as follows:

$$\\ {\sum }_{l = 1}^{L} {‖ {y}_{l} - {G}_{l} s ‖}^{2} = {\sum }_{l = 1}^{L} ( {‖ {y}_{l} ‖}^{2} + {s}^{{}_{} H} {G}_{l}^{{}_{} H} {G}_{l} s - 2 Re \{ {s}^{{}_{} H} {G}_{l}^{{}_{} H} {y}_{l} \} ) = ( {\sum }_{l = 1}^{L} {‖ {y}_{l} ‖}^{2} ) + {s}^{{}_{} H} ( {\sum }_{l = 1}^{L} {G}_{l}^{{}_{} H} {G}_{l} ) s - 2 Re \{ {s}^{{}_{} H} ( {\sum }_{l = 1}^{L} {G}_{l}^{{}_{} H} {y}_{l} ) \}$$

Consequently, by knowing only preprocessed data consisting of {Gₗ^{H}yᵢ} (i.e., L vectors of length K), the metric above can be evaluated for every candidate vector s, up to a constant that does not depend on s. This means that {Gₗ^{H}yᵢ} are sufficient statistics for the detection of s. Thus, each access point can, without loss of optimality, pre-compute the K-vector Gₗ^{H}yₗ and forward this quantity to the aggregation AP rather than forwarding the N-vector yₗ itself. This is true irrespective of which detection algorithm that is subsequently applied (maximum-likelihood, zero-forcing, MMSE, . . . ). If the aggregating AP in addition wants to perform other tasks, such as estimating the noise/interference level, it may also require the L scalars {∥yₜ∥²}. It is assumed here that the K×K Gramians {Gₗ^{H}Gₗ} are also provided to the aggregating AP, but these may change only once per coherence block and impose a fronthaul load that is independent of the number of antennas (N) and of the number of symbols to be detected.

In conclusion, if N>K then fronthaul load can be saved by pre-computing ∥yₗ∥² and Gₗ^{H}yₗ at the l^{th} access point, without losing any information (or losing optimality in the detection). In that case, the volume of data to be routed may be decreased by a factor up to N/K. If K≥N then there is nothing to be saved by this specific preprocessing.

The compression criterion N>K is applied directly for the case when all UEs' data from an AP needs to move to the same destination. If different subsets need to be transferred towards different aggregating APs, the compression needs to be partitioned into multiple blocks j where the criterion N>K, may be applied per block. Splitting and repacking of compressed blocks may be performed at APs where branching occurs, i.e. a certain AP's data needs to be routed over different outgoing segments for different UEs or UE subsets.

In some examples, a choice between forwarding signals per antenna element or signals per UE to the aggregation AP and performing cumulative combining may be made semi-dynamically, based on which approach results in less data transfer, as suggested above for examples of the method 400. For instance, when the number of UEs is large, different UEs may have different cooperating AP sets and aggregation APs with overlap, and/or advanced weight management approaches are used where channel estimates for non-served UEs are invoked for interference suppression purposes, it may be more efficient to transfer antenna symbols and channel estimates. In some examples, the same antenna signals and channel estimates may be routed in multiple directions from a certain AP.

When, on the other hand, the number of UEs is small and/or the UEs have predominantly disjoint cooperating AP sets and aggregation APs, cumulative combining along the route may be selected. In that case, a partially combined symbol per UE may be transferred in a single direction along a fronthaul route.

In some examples, there may be separate antenna signal forwarding mechanisms for antenna signals associated with uplink pilots and uplink data. Pilot signals may also be relevant for downlink transmissions. Pilot signals may also be used in some examples in the processing node to determine statistical channel properties, to make hardware scheduling decisions, and to determine the utilization of fronthaul resources.

In some example network deployments, the cooperating APs have no way of communicating with each other. In such cases, the processing node may for example assign multiple non-overlapping sets of cooperating APs, each with a different aggregation AP, and any final combining of symbol estimates may then occur in the processing node.

There is a tradeoff in some examples between processing speed in each AP and fronthaul speed due to local antenna signal forwarding. This may for example enable system design where the cost of the AP and fronthaul can be jointly considered. For example, a fast fronthaul may enable a more even distribution of the signal processing load in the network. For example, processing for signals from a UE may moved to an AP (the first AP or aggregation AP) that can be outside of the set of cooperating APs for that UE. Additionally or alternatively, for example, in the antenna signal forwarding step (e.g. step 402 and/or 1106 described above) it may be beneficial to move data as close to the processing node as possible to enable fast transfer of symbol estimates to the processing node after processing is done in the aggregation AP (e.g. in step 404 above).

In a 1D deployment, such as for example a Radio Stripes deployment, the selection of aggregation AP may be as follows in some examples. The cooperating AP closest to the processing node (e.g. CPU) may in some examples be selected as the aggregation AP. This makes it quicker to transfer symbol estimates to CPU. Alternatively, for example, The AP in the center of the cooperating AP set is selected as the aggregation AP. In such examples, more APs can send antenna signals to the aggregation AP within a fixed number of pipeline steps or time slots, which may result in better performance.

In a tree architecture (as described in for example Bertilsson et al, “A scalable architecture for massive MIMO base stations using distributed processing,” 2016 50th Asilomar Conference on Signals, Systems and Computers, IEEE 2016), similar considerations may apply in some examples. Specifically, for example, in some implementations it may be desirable to select tree branching points as aggregation APs. This may reduce the traffic on the fronthaul.

In some examples of this disclosure, UEs may be partitioned into different service classes, depending on their requirements on UL latency and reliability. For example, when a UE with specific requirements on latency is being served, its aggregation AP can be selected to be as close as possible to the processing node. When a UE with specific high requirements on reliability is being served, for example, a larger cooperating AP set may be selected to ensure improved beamforming gain and interference suppression.

In some examples, the cooperating AP set determined for a UE may be augmented. This may be done for example using UL channel statistics as described above. The augmentation may be done for example on the basis that signals forwarded by one aggregation AP to the CPU processing node may be transferred via a chain of other APs (unless the aggregation AP is a neighbour of the processing node). The APs in this chain need not necessarily to be in the original AP cooperating set. Therefore, since these APs carry the signals of the aggregation AP to the processing node, they may also contribute to the UL data detection process with their own measured signals without requiring additional fronthaul resources, nor changing the structure of the routing algorithms (e.g. the Greedy algorithm described above). Thus, for example, these APs may also measure UL channel and data signals, and may soft combine their own soft symbol estimates with the estimates from the aggregating AP, or alternatively for example the may forward their measured signals (UL channels and symbol estimates) together with the aggregation AP estimates to the processing node for further processing.

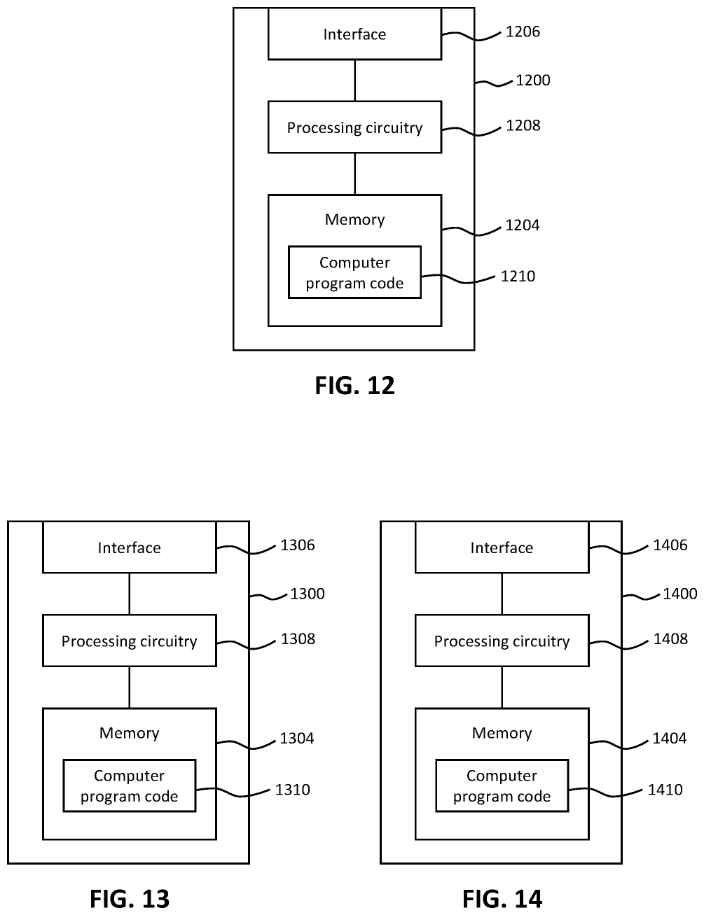

FIG. 12 is a schematic of an example of an apparatus 1200 in a first access point (AP) of processing signals from at least one User Equipment (UE). The apparatus 1200 comprises processing circuitry 1202 (e.g., one or more processors) and a memory 1204 in communication with the processing circuitry 1202. The memory 1204 contains instructions, such as computer program code 1210, executable by the processing circuitry 1202. The apparatus 1200 also comprises an interface 1206 in communication with the processing circuitry 1202. Although the interface 1206, processing circuitry 1202 and memory 1204 are shown connected in series, these may alternatively be interconnected in any other way, for example via a bus.

In one embodiment, the memory 1204 contains instructions executable by the processing circuitry 1202 such that the apparatus 1200 is operable/configured to receive, for each of at least one other access point, information based on signals received at one or more antennas of the other access point from the at least one UE, process the information based on the signals received at the one or more antennas of the at least one other access point to determine symbol estimates of symbols in the signals, and forward information identifying the symbol estimates to a processing node. In some examples, the apparatus 1200 is operable/configured to carry out the method 400 described above with reference to FIG. 4.

FIG. 13 is a schematic of an example of an apparatus 1300 in a processing node of selecting a first access point for processing information based on signals from at least one User Equipment (UE), wherein the at least one UE is to be served by at least one other access point. The apparatus 1300 comprises processing circuitry 1302 (e.g., one or more processors) and a memory 1304 in communication with the processing circuitry 1302. The memory 1304 contains instructions, such as computer program code 1310, executable by the processing circuitry 1302. The apparatus 1300 also comprises an interface 1306 in communication with the processing circuitry 1302. Although the interface 1306, processing circuitry 1302 and memory 1304 are shown connected in series, these may alternatively be interconnected in any other way, for example via a bus.

In one embodiment, the memory 1304 contains instructions executable by the processing circuitry 1302 such that the apparatus 1300 is operable/configured to: for each of the at least one UE, select a first access point for processing information based on signals received at one or more antennas of the at least one other access point from the at least one UE; and send, to the at least one other access point, information identifying the first access point selected for each of the at least one UE. In some examples, the apparatus 1300 is operable/configured to carry out the method 1000 described above with reference to FIG. 10.

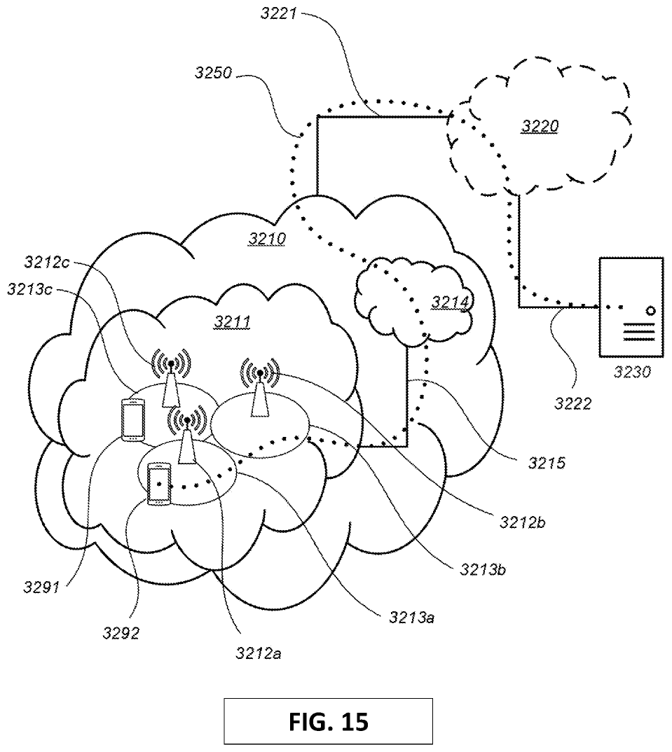

FIG. 14 is a schematic of an example of an apparatus 1400 in a second access point for sending information to a first access point. The apparatus 1400 comprises processing circuitry 1402 (e.g., one or more processors) and a memory 1404 in communication with the processing circuitry 1402. The memory 1404 contains instructions, such as computer program code 1410, executable by the processing circuitry 1402. The apparatus 1400 also comprises an interface 1406 in communication with the processing circuitry 1402. Although the interface 1406, processing circuitry 1402 and memory 1404 are shown connected in series, these may alternatively be interconnected in any other way, for example via a bus.

In one embodiment, the memory 1404 contains instructions executable by the processing circuitry 1402 such that the apparatus 1400 is operable/configured to receive, from a processing node, an indication of a first access point, receive signals at one or more antennas of the second access point from at least one User Equipment (UE), and send, to the first access point, information based on signals received at the one or more antennas of the second access point from the at least one UE. In some examples, the apparatus 1400 is operable/configured to carry out the method 1100 described above with reference to FIG. 11.

Examples of the present disclosure also include apparatus in a first access point (AP) for processing signals from at least one User Equipment (UE). The apparatus comprises a receiving module configured to receive, for each of at least one other access point, information based on signals received at one or more antennas of the other access point from the at least one User Equipment (UE); a processing module configured to process the information based on the signals received at the one or more antennas of the at least one other access point to determine symbol estimates of symbols in the signals; and a forwarding module configured to forward information identifying the symbol estimates to a processing node.

Examples of the present disclosure also include apparatus in a processing node of selecting a first access point for processing information based on signals from at least one User Equipment (UE), wherein the at least one UE is to be served by at least one other access point. The apparatus comprises a selecting module configured to, for each of the at least one UE, select a first access point for processing information based on signals received at one or more antennas of the at least one other access point from the at least one UE; and a sending module configured to send, to the at least one other access point, information identifying the first access point selected for each of the at least one UE.

Examples of the present disclosure also include apparatus in a second access point for sending information to a first access point. The apparatus comprises a first receiving module configured to receive, from a processing node, an indication of a first access point; a second receiving module configured to receive signals at one or more antennas of the second access point from at least one User Equipment (UE); and a sending module configured to send, to the first access point, information based on signals received at the one or more antennas of the second access point from the at least one UE.

With reference to FIG. 15, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 15 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

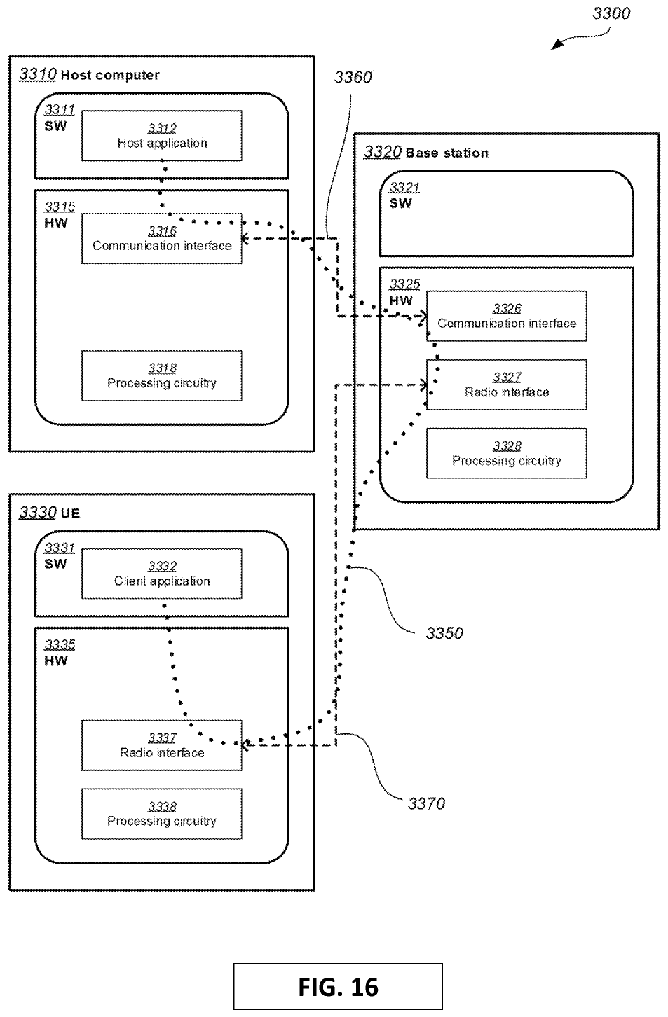

Example implementations, in accordance with an embodiment, of the UE, base station and host computer discussed in the preceding paragraphs will now be described with reference to FIG. 16. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 16) served by the base station 3320. The communication interface 3326 may be configured to facilitate a connection 3360 to the host computer 3310. The connection 3360 may be direct or it may pass through a core network (not shown in FIG. 1164) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 16 may be identical to the host computer 3230, one of the base stations 3212a, 3212b, 3212c and one of the UEs 3291, 3292 of FIG. 1153, respectively. This is to say, the inner workings of these entities may be as shown in FIG. 16 and independently, the surrounding network topology may be that of FIG. 15.

In FIG. 16, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

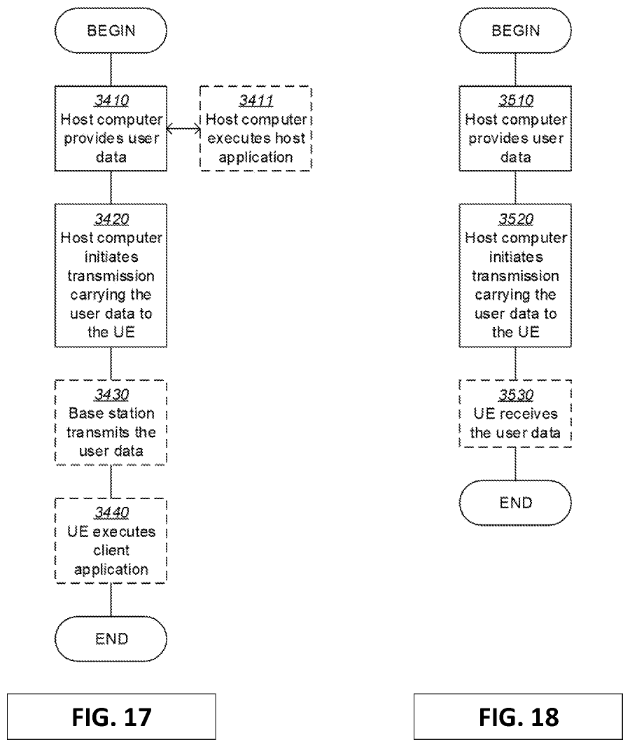

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

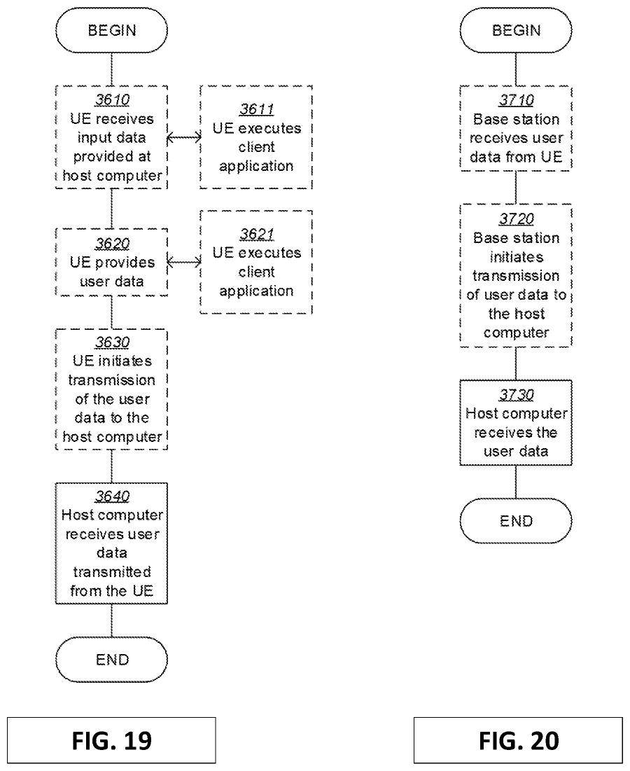

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a first access point, AP, of processing signals from at least one User Equipment (UE), the method comprising:
receiving, for each of at least one other access point, information based on signals received at one or more antennas of the other access point from the at least one User Equipment, UE;
processing the information based on the signals received at the one or more antennas of the at least one other access point to determine symbol estimates of symbols in the signals; and
forwarding information identifying the symbol estimates to a processing node.

2. The method of claim 1, comprising:
receiving signals at one or more antennas of the first access point from the at least one UE;
wherein processing the signals from the at least one other access point to determine symbol estimates of symbols in the signals comprises processing the signals received at the one or more antennas of the at least one other access point and the signals received at the one or more antennas of the first access point to determine the symbol estimates of the symbols in the antenna signals.

3. The method of claim 1, wherein receiving the information based on signals received at one or more antennas of the at least one other access point comprises receiving the information for a plurality of other access points simultaneously over a plurality of fronthaul segments connected to the first access point.

4. The method of claim 1, comprising:
receiving further signals at one or more antennas of the first access point from at least one further UE; and
sending information based on the further signals to a further access point.

5. The method of claim 4, wherein the at least one other access point includes the further access point.

6. The method of claim 4, comprising receiving an indication of the further access point from the processing node.

7. The method of claim 4, wherein the information based on the further signals comprises information identifying the further signals from the one or more antennas of the first access point.

8. The method of claim 4, wherein the information based on the further signals comprises information identifying antenna signals from the one or more antennas of the first access point combined with weights based on channel responses between each of the at least one further UE and each of the one or more antennas of the first access point.

9. The method of claim 8, comprising sending information identifying a magnitude of a vector representing the antenna signals to the further access point.

10. The method of claim 4, wherein sending the information based on the further signals to the further access point comprises:
sending information identifying signals received at the one or more antennas of the first access point if a number of the at least one further UE is greater than a number of the one or more antennas of the first access point; and
sending information identifying signals received at the one or more antennas of the first access point combined with weights based on channel responses between each of the at least one further UE and each of the one or more antennas of the first access point if the number of the at least one further UE is greater than the number of the one or more antennas of the first access point.

11. The method of claim 1, wherein receiving, for each of one or more of the at least one other access point, the information based on signals received at one or more antennas of the other access point comprises receiving information identifying the signals from the one or more antennas of the other access point.

12. The method of claim 1, wherein receiving, for each of one or more of the at least one other access point, the information based on signals received at one or more antennas of the other access point comprises receiving information identifying the signals received at the one or more antennas of the other access point combined with weights based on channel responses between each of the at least one UE and each of the one or more antennas of the other access point.

13. The method of claim 12, comprising receiving, for each of one or more of the at least one other access point, information identifying a magnitude of a vector representing the signals received at the one or more antennas of the other access point.

14. The method of claim 13, wherein processing the information based on the signals received at the one or more antennas of the at least one other access point to determine symbol estimates of symbols in the antenna signals comprises processing the information based on the signals received at the one or more antennas of the at least one other access point and the information identifying a magnitude of a vector representing the antenna signals to determine symbol estimates of symbols in the antenna signals.

15. The method of claim 1, wherein the at least one other access point comprises a group of access points serving the at least one UE.

16. The method of claim 15, wherein the group of access points includes the first access point.

17. The method of claim 1, wherein the signals received at the one or more antennas of the at least one other access point from the at least one UE comprise one or both pilot signals and data signals.

18. The method of claim 1, comprising receiving, from at least one additional first access point, information identifying additional symbol estimates of symbols in signals from at least one additional UE, wherein the information identifying additional symbol estimates of symbols in signals from at least one additional UE is received simultaneously with forwarding information identifying the symbol estimates to a processing node.

19. The method of claim 18, wherein receiving, from at least one additional first access point, information identifying additional symbol estimates of symbols in signals from at least one additional UE comprises receiving the information in a first time slot, and the method further comprises forwarding the information identifying the additional symbol estimates to the processing node in a second time slot after the first time slot.

20.-28. (canceled)

29. A method of sending information to a first access point in a second access point, the method comprising:
receiving, from a processing node, an indication of a first access point;
receiving signals at one or more antennas of the second access point from at least one User Equipment, UE;
sending, to the first access point, information based on signals received at the one or more antennas of the second access point from the at least one UE;
receiving, from at least one other access point, information based on signals received at one or more antennas of the at least one other access point from the at least one UE; and
forwarding the information based on the signals received at the one or more antennas of the at least one other access point to the first access point.

30.-55. (canceled)
